(19) United States
(12) Patent Application Publication
(10) Pub. No.: US 2026/0000036 A1
(43) Pub. Date: Jan. 1, 2026

(54) Clog Resistant Drip Emitter

(71) Applicant: Rain Bird Corporation, Azusa, CA (US)

(72) Inventors: Mark Murphy Ensworth, Orange, CA (US); Kenny Cuong Phong, Chino Hills, CA (US); Michael A. McAfee, Tucson, AZ (US)

(21) Appl. No.: 18/756,790

(22) Filed: Jun. 27, 2024

(51) Int. Cl. A01G 25/02

(52) U.S. Cl. CPC A01G 25/023

(57) ABSTRACT

A drip emitter is provided having a clog-resistant, debris-clearing inlet filter. The emitter includes a moveable inlet that has an outer side exposed to the fluid in the supply tube, an inner side facing an interior of the emitter, and at least one inlet opening. In an operational state of the emitter, the moveable inlet moves from a first state to a second state as a result of debris at least partially blocking the at least one inlet opening. In the second state, at least some of the debris is cleared away from the inlet opening, resuming normal flow and causing the moveable inlet to move back towards the first state.

### FIELD

This disclosure relates to irrigation drip emitters, and, more particularly, to drip emitters that prevent debris build-up.

### BACKGROUND

Drip emitters are commonly used in irrigation systems to convert water flowing through a supply tube at a relatively high flow rate to a relatively low flow rate at the outlet of each emitter. Each drip emitter generally includes a housing defining a flow path that reduces high pressure water entering the drip emitter into relatively low pressure water exiting the drip emitter. Multiple drip emitters are commonly mounted on the inside or outside of a water supply tube. In one type of system, many drip emitters are mounted at regular and predetermined intervals along the length of the supply tube to distribute water at precise points to surrounding land and vegetation.

When drip irrigation is employed, however, clogging of the emitters can be a significant problem. In emitters with inadequate filtration, grit can gradually accumulate within the small passages of drip emitters, which can lead to partial or complete blockages. As the flow of water through the emitters is restricted or stopped by these blockages, water is unevenly distributed in the irrigation system, with certain areas receiving insufficient water. This leads to stress on the vegetation. With crops, this could lead to lower yields.

To mitigate these issues, large serviceable filtration systems are often installed to filter the water before it enters the dripline. However, such systems can be expensive to both purchase and maintain. Additionally, many emitter manufacturers design passive filters at the inlet of each emitter to ensure only clean water enters the emitter flow path. However, even if a passive filter is employed at the inlet of the emitter to prevent grit or other particulate matter from entering the emitter, the filter itself can still clog over time. For inline emitters that are inaccessible inside the dripline, this limits the operational life of the emitter since cleaning or replacing the filter is not possible. Moreover, the process of detecting and servicing clogged emitters is labor-intensive and costly, adding to the operational challenges for growers.

There is a need to improve drip emitters so that they are resistant to clogs to ensure proper flow and reduce failure.

### BRIEF DESCRIPTION OF THE DRAWINGS

FIG. 1 is a top, front-side perspective view of a drip emitter according to an embodiment.

FIG. 2 is a bottom, back-side perspective view of the drip emitter of FIG. 1.

FIG. 3 is a front-side elevational view of the drip emitter of FIG. 1.

FIG. 4 is a cross-sectional view of the drip emitter of FIG. 1 taken along line 4-4 of FIG. 1.

FIG. 5 is a cross-sectional view of the drip emitter of FIG. 1 taken along line 5-5 of FIG. 1.

FIG. 6 is an exploded view of the drip emitter of FIG. 1.

FIG. 7 is a top, front-side perspective view of a first housing of the drip emitter of FIG. 1.

FIG. 8 is a bottom, back-side perspective view of the first housing of FIG. 7.

FIG. 9 is a bottom plan view of the first housing of FIG. 7.

FIG. 10 is a top, front-side perspective view of a second housing of the drip emitter of FIG. 1.

FIG. 11 is a top plan view of the second housing of FIG. 10.

FIG. 12 is a bottom plan view of the second housing of FIG. 10.

FIG. 13A is a top perspective view of an inlet filter of the drip emitter of FIG. 1.

FIG. 13B is a bottom perspective view of the inlet filter of FIG. 13A.

FIG. 13C is a side elevational view of the inlet filter of FIG. 13A.

FIG. 13D is a perspective cross-sectional view of the inlet filter of FIG. 13A taken along line 13D-13D of FIG. 13A.

FIG. 14 is a partial cross-sectional view of the drip emitter of FIG. 1 taken along line 4-4 of FIG. 1 showing the inlet filter in a grit-clearing, deflected state.

FIG. 15 is a close-up perspective view of an inlet filter of a drip emitter according to a second embodiment.

FIG. 16 is a cross-sectional view of the drip emitter of FIG. 1 taken along line 4-4 of FIG. 1 shown mounted to a supply tube.

### DETAILED DESCRIPTION

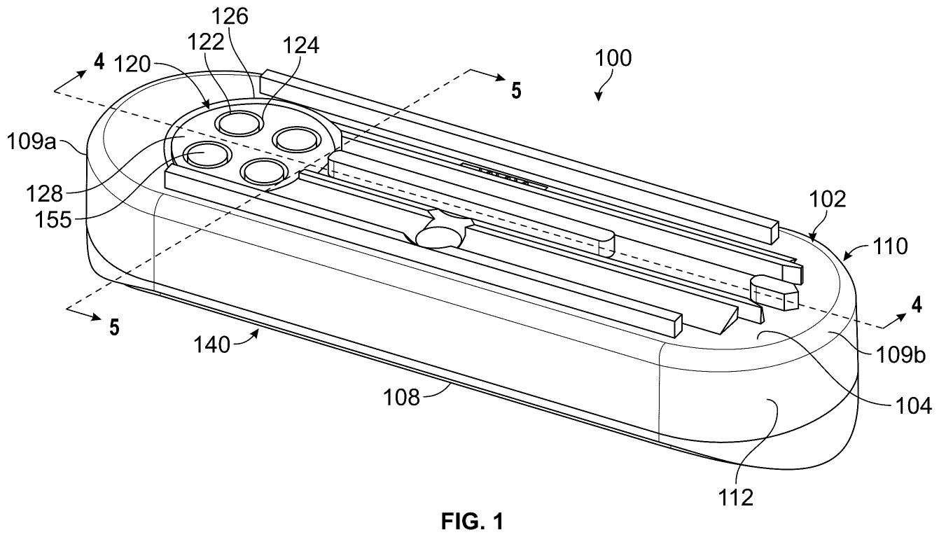

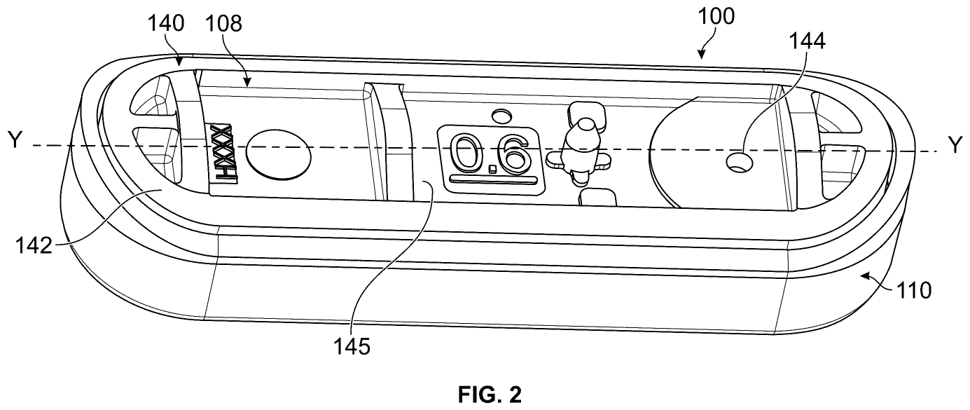

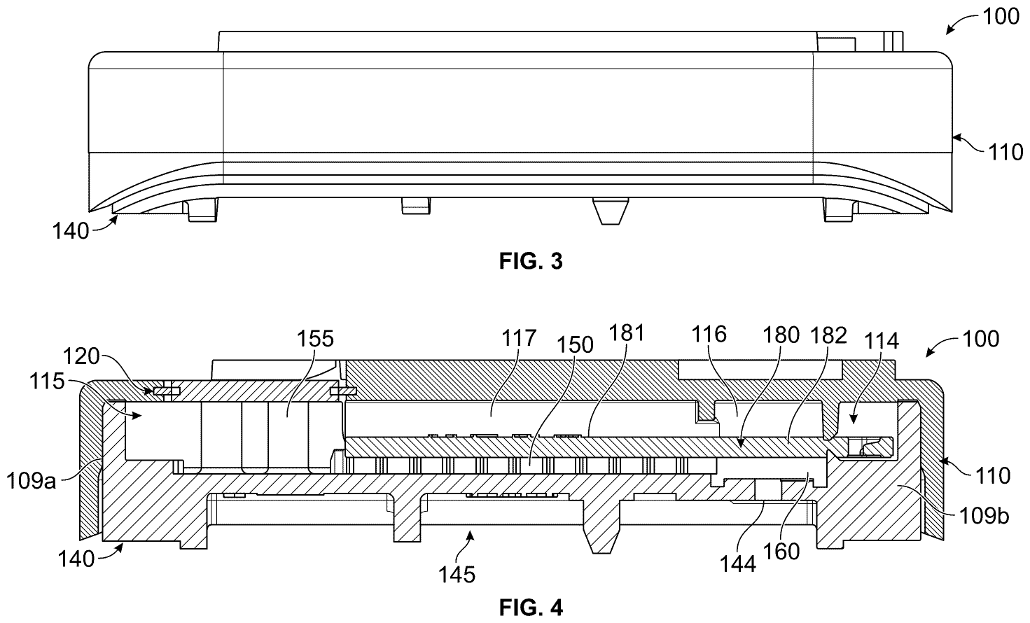

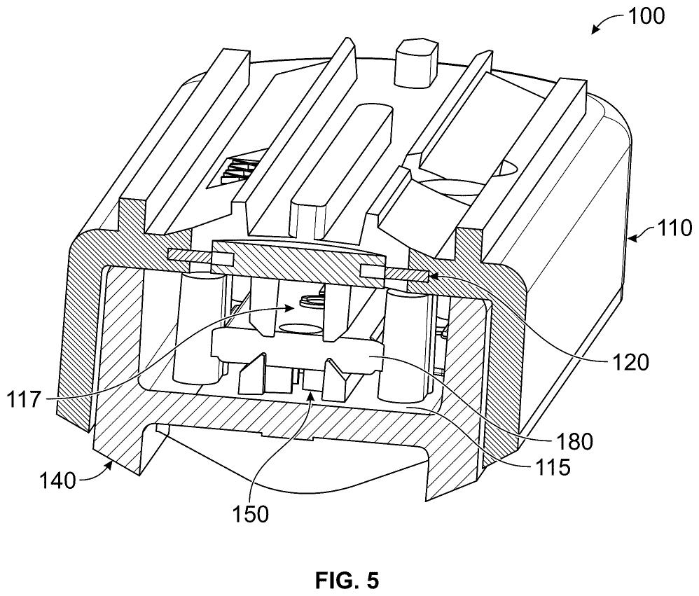

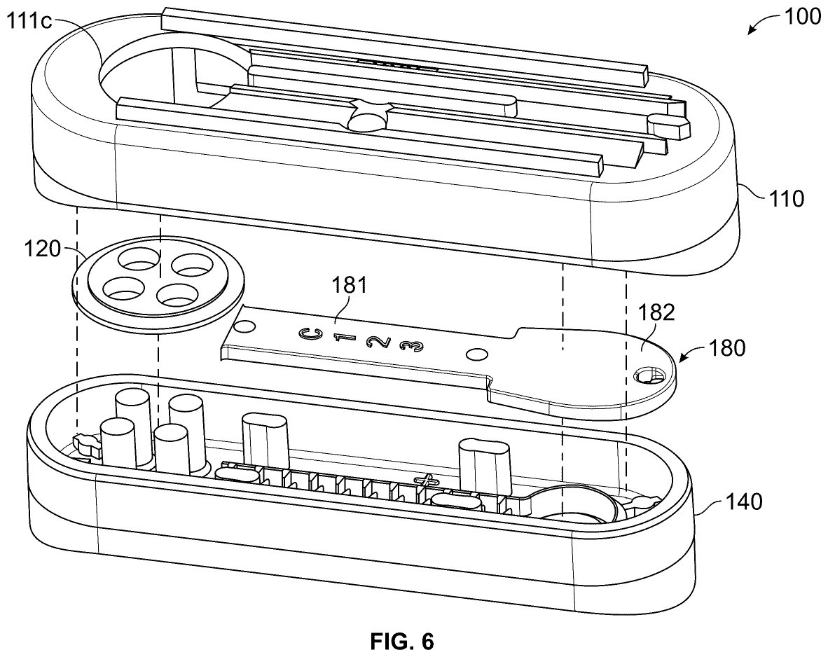

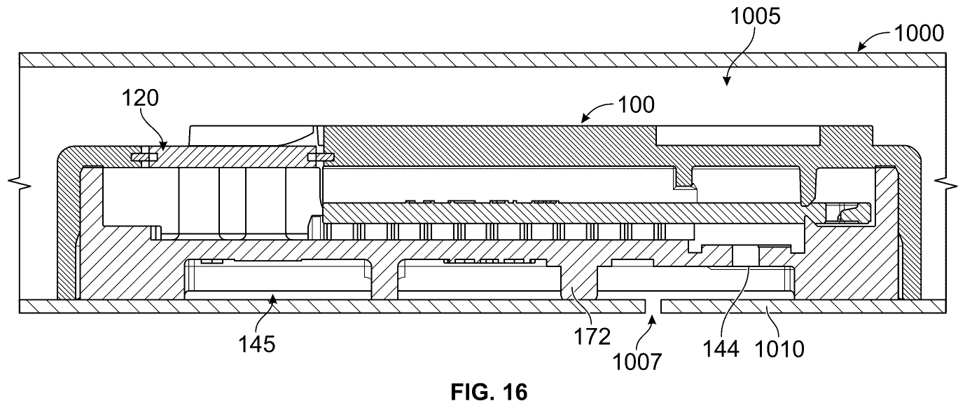

With reference to FIGS. 1-6 and 16, there is illustrated an irrigation drip emitter 100 that may be mounted inside a dripline and used to distribute water from a supply conduit at a low flow rate. A dripline may include many of these emitters 100 spaced at predetermined intervals along the dripline.

Advantageously, the drip emitter 100 is clog-resistant due to a moveable or “active” inlet filter 120. The inlet filter 120 both prevents grit or other debris from entering the emitter 100 and ejects grit or debris from the inlet filter to resist clogging of the filter. More specifically, the inlet filter 120 takes advantage of a pressure drop that occurs across the inlet filter 120 when debris accumulates on the inlet filter 120 to a certain level. The pressure drop causes the inlet filter 120 to deflect inwardly into the emitter, allowing the accumulated debris to be ejected away from the inlet filter 120 before the inlet filter 120 returns to its neutral state. Since the inlet filter 120 is self-cleaning, permitting automatic clearing of any debris accumulation at the inlet, the emitter 100 is clog-resistant so as to extend its operational life and lessens dependence on costly water filtration systems.

Generally, the emitter 100 is provided for delivering irrigation water from a water supply conduit, such as an irrigation supply tube 1000, at a low volume, substantial trickle, or drip flow rate. The emitter 100 uses a tortuous pressure-reducing flow passage 150 that causes a pressure reduction between the irrigation supply tube 1000 and an emitter outlet 144. Specifically, high pressure water enters the emitter 100 from a supply tube 1000 at an inlet portion 115 of the emitter 100, travels through the pressure-reducing flow passage 150, and exits the emitter from the outlet 144 at a significantly reduced pressure.

The emitter 100 includes a compact housing 102 made of a generally sturdy and non-corrosive material. The emitter 100 includes a first side or inlet side 104 that is exposed to an interior 1005 of the tube 1000 to receive water therefrom and a second side or base 108 opposite the first side 104 that includes the emitter outlet 144.

In embodiments, the emitter 100 is an inline emitter, configured to be mounted within the supply tube 1000. For instance, the emitter 100 may be mounted so that the base 108 is sealingly affixed to an inside surface or wall 1010 of the supply tube 1000. In some embodiments, the base 108 of the emitter includes a raised rim 142 extending about the perimeter of the base 108 that is bonded into sealing engagement with the inside surface 1010 of the tube 1000. In embodiments, many emitters 100 are mounted within an irrigation tube 1000 at predetermined spaced intervals. As described further below, each emitter outlet 144 communicates water to an adjacent tube outlet 1007 (an opening defined in the wall 1010 of the tube 1000 adjacent the emitter 100) where water is discharged to the surrounding terrain.

In non-limiting embodiments, the emitter housing 102 may include a first housing 110 and a second housing 140 that are fitted together to form the emitter 100. The first housing 110 and the second housing 140 may be molded plastic components (e.g., a rigid plastic). The first housing 110 is adapted for assembly with the second housing 140 to form a substantially enclosed housing interior 114, which encloses a diaphragm 180. In other embodiments, the emitter 100 may be an elastomeric emitter with an elastomeric housing (e.g., a one-piece elastomeric housing), such as those described in U.S. application Ser. No. 18/171,313, filed Feb. 17, 2023 and in U.S. Pat. No. 11,051,466 the contents of which are incorporated herein by reference in their entireties.

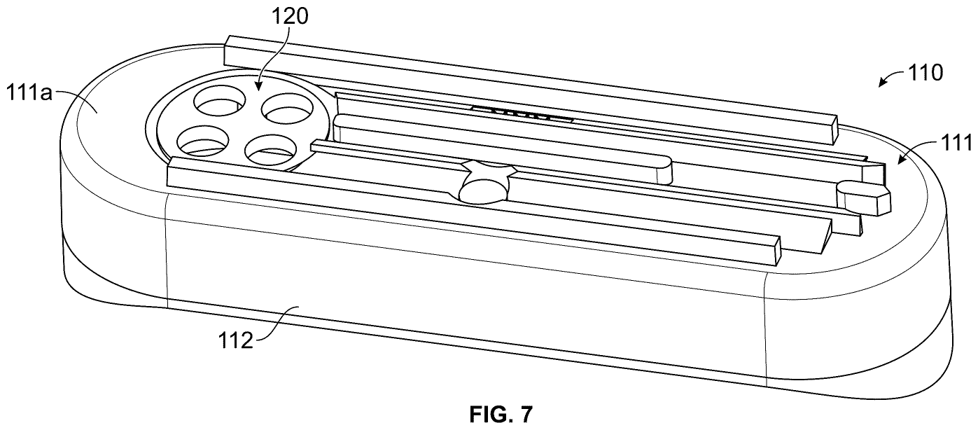

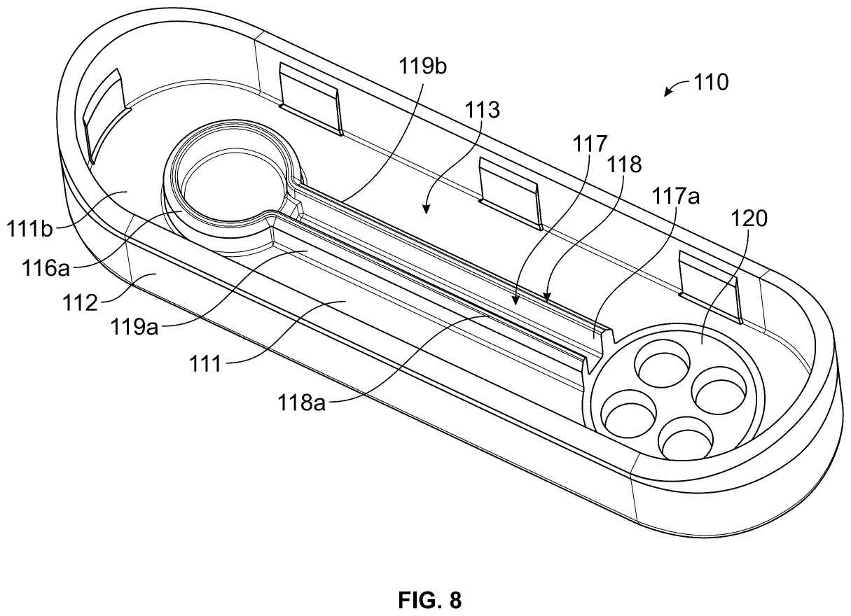

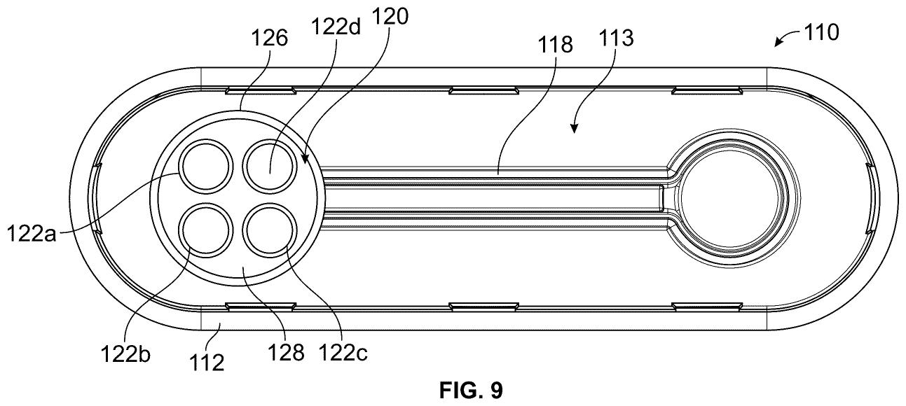

With reference to FIGS. 1, 4, and 6-9, the first housing 110 includes an elongated base 111 and a side wall 112 extending about the periphery of the base 111 to define a cavity 113. The cavity 113 is sized to receive at least a portion of the second housing 140 when the housings 110, 140 are assembled together. A first exterior side 111a of the base 111 is exposed to the water flowing through the supply tube while a second interior side 111b of the base 111 defines a portion of the interior 114 of the emitter 100. Specifically, water passes through the base 111 into the interior 114 of the emitter 100 through one or more inlet openings 122 of the inlet filter 120, described further below.

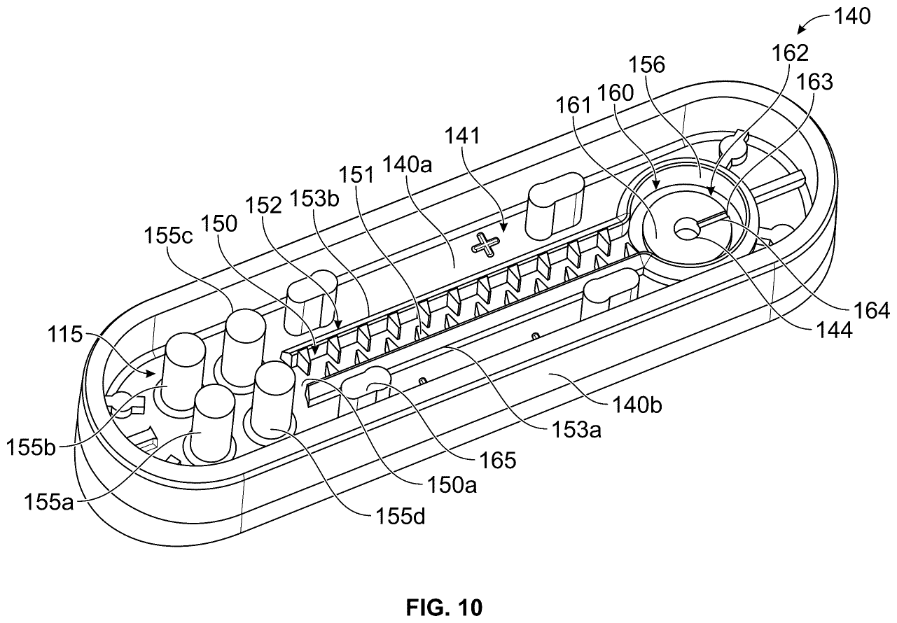

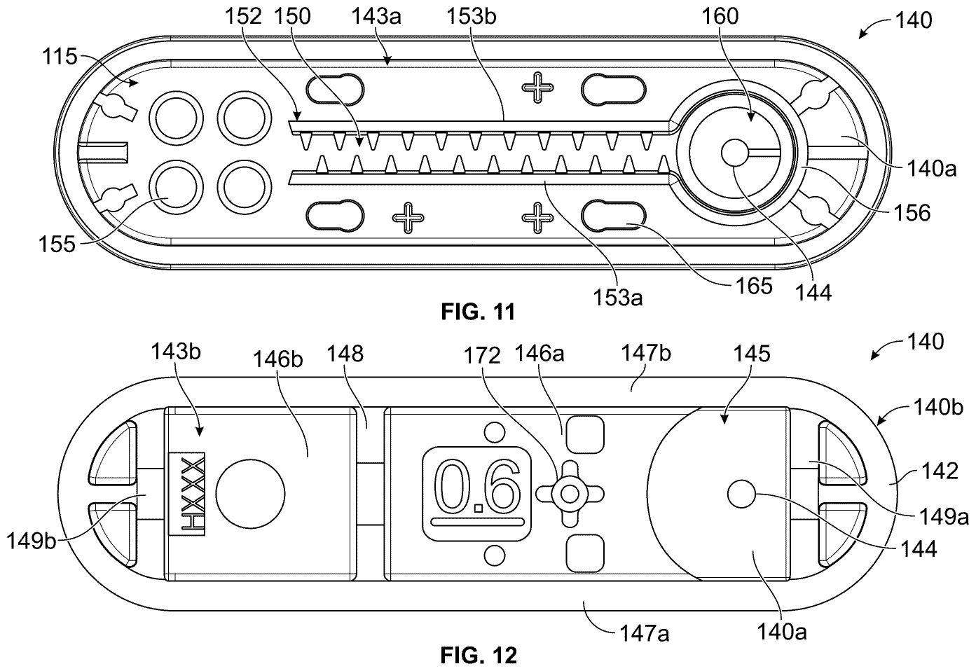

With reference to FIGS. 1, 4, 10-12, and 16, the second housing 140 also includes an elongated base 140a and a side wall 140b extending about the periphery of the base 140a. As illustrated, the second housing 140 may be sized to be almost entirely contained within the first housing 110. The first housing 110 and the second housing 140 may be welded or otherwise bonded together at various points, such as between the side walls 112, 140b of each respective component. A first side 143a of the second housing 140 may define a portion of the interior 114 of the emitter 100, while an opposite, second side 143b of the second housing 140 may define an exterior side of the second housing 140 and of the emitter 100. In embodiments, the side wall 140b of the second housing 140 forms the raised rim 142 to mount the emitter 100 to the tube wall 1010. The second side 143b further defines an outlet bath 145 between the base 140a of the second housing 140, the raised rim 142, and the tube wall 1010. The emitter outlet 144 extends through the base 140a. Water flows out the emitter outlet 144 into the outlet bath 145 before discharging out of the tube 1000 through the tube outlet 1007.

As described further below, the first housing 110, the second housing 140, and the diaphragm 180 combine to define a pressure-reducing flow passage 150 and a pressure-compensation chamber 116 for achieving a desired flow at the outlet 144.

With reference to FIGS. 1, 4, 6, 10, 13A-13D and 16, the emitter 100 includes the deflectable inlet filter 120 at the first side 104 of the emitter 100. The inlet filter 120 includes one or more inlet openings 122 that permit water from the supply tube 1000 to pass into an inlet portion 115 of the interior 114 of the emitter 100, while inhibiting entry of grit or other particulate matter.

Specifically, the one or more inlet openings 122 extend through a plate 128 of the inlet filter 120. The plate 128 may be generally planar and extends through the base 111 of the first housing 110. In some approaches, the plate 128 is round or circular. A first side 129 of the plate 128 faces the interior 1005 of the supply tube 1000 and a second side 130 of the plate 128 faces the interior 114 of the emitter. In a neutral position of the inlet filter 120 (e.g., where there is no debris blockage), the first side 129 (e.g., the top surface) of the plate 128 may be generally coplanar with a top exterior surface of the housing 110. In some embodiments, the thickness of the plate 128 may be substantially the same as a thickness of the base 111 of the first housing 110.

The plate 128 is coupled to the base 111 via an elastomeric ring or diaphragm 126 that engages and extends about the plate 128. Because of the flexibility of the elastomeric ring 126, the plate 128 is moveable or deflectable relative to the base 111, as described further below.

Specifically, a radially outward portion of the elastomeric ring 126 is coupled to the base 111 while a radially inward portion of the elastomeric ring 126 is coupled to the plate 128. Together, the plate 128 and the elastomeric ring 126 are sized to fit within a hole 111c of the base 111. In one approach, the elastomeric ring 126, base 111, and plate 128 are coupled together in a two-shot molding process. For instance, the material for the elastomeric ring may be injected into the mold first, and the material for the base 111 and the plate 128 (e.g., a rigid plastic) may be injected secondly around each side of the elastomeric ring to captivate the elastomeric ring therebetween. A portion of the elastomeric ring 126 hangs freely in the annular space between the base 111 and the plate 128, permitting the elastomeric ring 126 to deflect under certain conditions.

The plate 128 may include, for example, four spaced inlet openings 122 (e.g., 122a, 122b, 122c, 122d). Other amounts of inlet openings 122 are also possible, for instance, one, two, three, five, six, seven, eight, or more. In an exemplary approach, the number of inlet openings ranges from two to four. The inlet openings 122 may be disposed generally symmetrically on the plate 128, for instance, in a square or diamond configuration. The inlet openings 122 also may be spaced on the plate 128 in other configurations. The inlet openings 122 may be generally circular, though other shapes are possible. In the illustrated form, the inlet openings 122 are circular with a gradually increasing diameter from the first side 129 of the plate 128 to the second side 130 of the plate 128 to prevent any particles that are small enough to pass the inlet opening from jamming the annular passages 124 of the inlet openings 122 and preventing the plate from moving.

The inlet filter 120 functions in tandem with one or more rods 155 that project within the interior 114 of the emitter 100 from the elongated base 140a of the second housing 140 and towards the one or more inlet openings 122. The rods 155 are sized and positioned to extend centrally through the inlet openings 122 (e.g., one rod through each opening). For instance, in some approaches where the inlet openings 122 are circular, the rods 155 are cylindrical and have a diameter selected so that the rods 155 extend within the inlet openings 122. The number of rods 155 may correspond to the number of inlet openings 122 so that each inlet opening 122 has a corresponding rod 155 extending therethrough. For instance, as illustrated, there may be four rods 155 (155a, 155b, 155c, 155d) extending from the base 140a of the second housing 140 and into the inlet openings 122 (122a, 122b, 122c, 122d). In embodiments, a length of the rods 155 may be selected so that in a neutral position of the inlet filter 120 the rods 155 extend within the inlet openings 122 and are generally level with the first side 129 of the plate 128. This flush position reduces or eliminates interference by the rods 155 of the flow through the tube 1000.

Specifically, each rod 155 has a diameter such that when the rod 155 extends centrally through the corresponding inlet opening 122, an annular space between the rod 155 and the perimeter of the inlet opening 122 is formed, defining an annular inlet passage 124. Thus, water flows from the tube 1000 into the emitter 100 through one or more annular inlet passages 124 formed between the one or more rods 155 and the corresponding one or more inlet openings 122. The annular inlet passage 124 may have a uniform width or may have a gradually increasing width. In either configuration, the number of inlet openings 122, the initial diameters (at the entry) of the inlet openings 122, and the diameters of the corresponding rods 155 may be selected so that the resulting width of the annular inlet passages 124 define a sufficient initial flow area to attain an operational flow into the emitter while being narrow enough to restrict grit or other debris from entering the emitter 100. For instance, in some approaches the width of the annular inlet passages 124 may be reduced to filter smaller particles while the number and/or the diameter of the inlet openings 122 is increased to still achieve a sufficient flow into the emitter 100. In other approaches, the width of the annular inlet passages 124 may be increased and the number and/or diameter of the inlet openings 122 reduced to achieve the same overall inlet flow area.

In some embodiments, for example, an initial diameter of one or more of the inlet openings 122 is about 0.030 inches to about 0.12 inches or about 0.060 inches to about 0.090 inches while an initial width of the annular inlet passage 124 (i.e., a width of the space between the inlet opening 122 and the rod 155 at the entry) is about 0.002 inches to about 0.008 inches or about 0.003 inches to about 0.006 inches. In some embodiments, a diameter of one or more of the rods 155 may be about 0.02 inches to about 0.11 inches or about 0.05 inches to about 0.08 inches.

In some embodiments, the relative initial diameters of the inlet openings 122 and the diameters of the rods 155 are sized so that a resulting initial width of the annular inlet passages 124 prevents particles larger than a specific mesh size from passing into the emitter 100. For instance, in various approaches, the annular inlet passages 124 prevent particles larger than 80 mesh, larger than 100 mesh, larger than 120 mesh, larger than 140 mesh, or larger than 200 mesh from entering the emitter 100.

In some embodiments, each annular inlet passage 124 has an initial cross-sectional flow area at the entry to the annular inlet passage 124 from about 0.0002 in² to about 0.0008 in². In embodiments, the initial cross-sectional flow area is selected to be large enough to not cause deflection of the inlet filter 120 when the inlet openings 122 are not obstructed. In some embodiments, the annular inlet passages 124 in combination have a total initial cross-sectional flow area at the entry to the passages 124 of from about 0.0008 in² to about 0.0032 in².

As illustrated, each of the inlet openings 122 may be the same size and each of the rods 155 may be the same size. Thus, each annular inlet passage 124 also may be the same size. In other approaches, the inlet openings 122, rods 155, and/or annular inlet passages 124 may be varied in size.

As noted above, the moveable or deflectable inlet filter 120 is clog-resistant. Conventional filters have the disadvantage of lacking a mechanism for automatically clearing grit or debris that gets caught in the filter. Thus, nothing stops debris from building up over time on the filter and clogging the emitter inlet. This is a significant problem for inline emitters, since the emitters are inaccessible within the dripline and thus cleaning or replacing the filter is not possible.

The moveable inlet filter 120, however, permits automatic clearing of grit from the inlet filter 120 when grit builds up, preventing clogs from forming at the inlet openings 122 and extending the life of the emitter. Specifically, the moveable inlet filter 120 takes advantage of the pressure drop across the inlet filter 120 that occurs when debris starts to block the inlet openings 122, moving or deflecting from a first state (or neutral state) to a second, debris-clearing state.

More specifically, FIG. 4 shows the inlet filter 120 in a first, neutral state or position. This occurs when there is no or substantially no pressure drop across the plate 128. For instance, the neutral state may occur when the amount of debris caught at the inlet filter 120 is insufficient to substantially block much of the cross-sectional area of the inlet filter 120 so as to cause a pressure drop across the inlet filter 120 or plate 128. That is, the pressure in the supply tube 1000 and the pressure in the inlet portion 115 of the emitter are substantially the same. In the neutral state, the elastomeric ring 126 is in a neutral position holding the plate 128 so that it is substantially level with the top surface of the housing 110. In this position, the first side 129 of the plate 128 also may be substantially level with the terminal ends of the rods 155 extending through the inlet openings 122. Water freely moves into the emitter 100 through the annular inlet passages 124, and the narrow annular inlet passages 124 prevent grit or debris from entering the emitter 100. Any debris that passes into the emitter should be small enough to flow through the emitter and out of the tube.

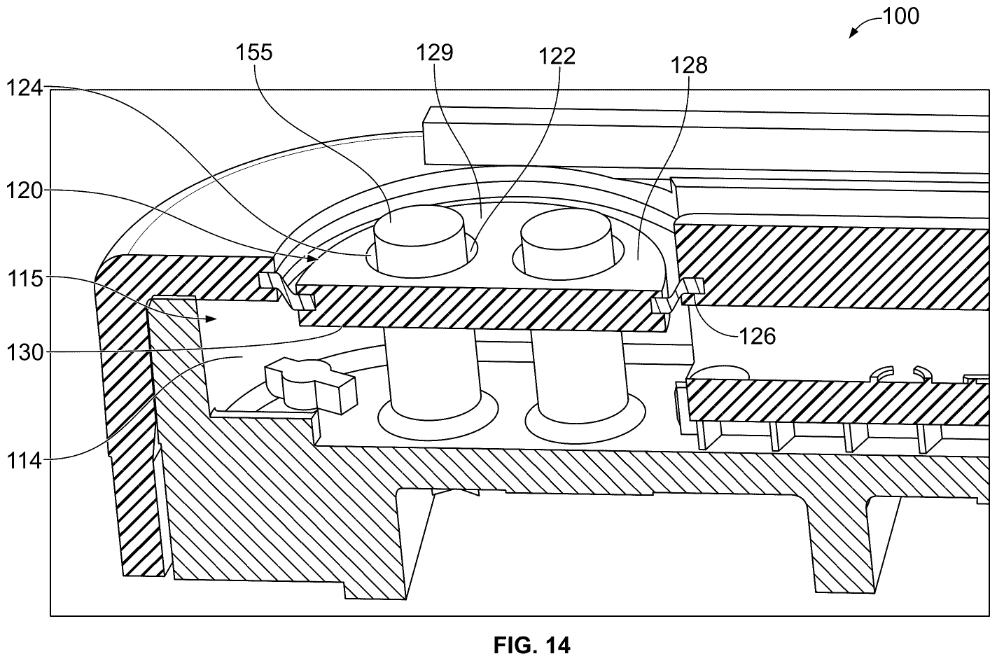

Over time, debris may begin to build up or catch at the inlet openings 122 and block flow area through the annular inlet passages 124. As a result of the lessened flow area into the emitter 100, a pressure drop occurs across the inlet filter 120, with higher pressure in the tube than inside the emitter 100. The pressure drop in the emitter causes the plate 128, carried by and moveable via the elastomeric ring 126, to move inwardly into the emitter 100 because of the higher pressure water in the tube pressing against the plate 128. In this deflected, debris-clearing state, as shown in FIG. 14, the plate 128 displaces relative to both the top surface of the housing 110 and relative to the rods 155, so that the terminal end portions of the rods 155 project out from the inlet openings 122, exposed to the flow in the tube. Specifically, the movement of the plate 128 farther into the interior 114 of the emitter 100 moves the inlet openings 122 away from the terminal end portions of the rods 155. This action disrupts and dislodges the debris at the interface between the inlet openings 122 and the rods 155 blocking the annular inlet passages 124, allowing the loosened debris to be flushed away by the flow in the tube and/or deposited away from the emitter. In addition, the moving of the plate 128 relative to the rods 155 increases the exposure of the terminal end portions of the rods 155 to the high-pressure flow in the tube 1000 which clears away any debris clinging thereto.

After the debris is cleared away and no longer blocks the annular inlet passages 124, the flow area into the emitter 100 increases, reducing the pressure drop across the plate 128. That is, the pressure inside the drip emitter increases and forces the plate towards its undeflected, neutral state and position.

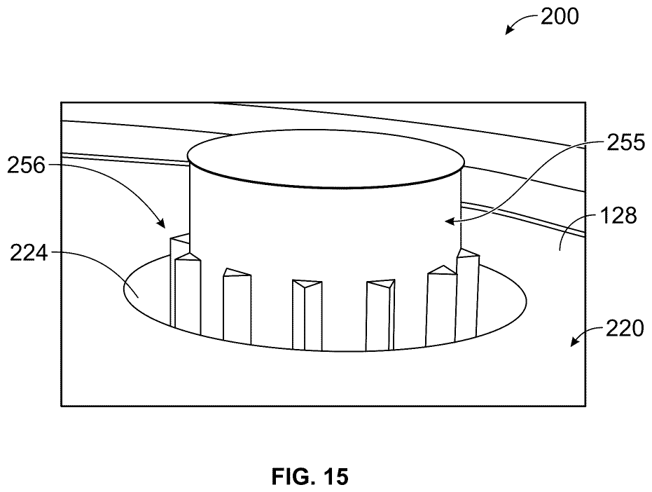

In embodiments, the rods 155 have a completely smooth outer side surface. In other approaches, as shown in FIG. 15, an emitter 200 may include a plurality of debris-clearing ribs 256 on the rods 155. For instance, as shown, the ribs 256 may be longitudinal ribs spaced about a top portion of the rod 155. In some embodiments, the ribs 256 have a pointed, tapered, or triangular profile. The ends of the ribs 256 may be spaced slightly from the terminal end of the rod 155, leaving a smooth surface of the rod 155 therebetween.

The ribs 256 assist in clearing debris from the annular inlet passages 224. Specifically, when the inlet filter 220 moves into the grit-clearing state, as shown in FIG. 15, the plate 228 may be moved below the tops of the ribs 256, which disrupts and clears the debris away from the annular inlet passages 224.

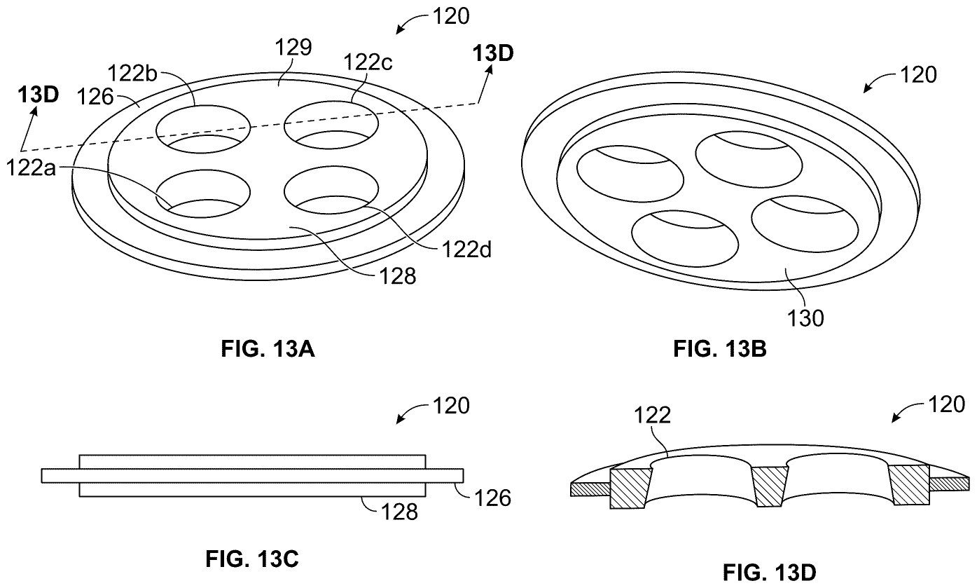

With reference to FIGS. 1 and FIGS. 13A to 13D, to ensure that the inlet filter 120 deflects at a specific pressure drop when the annular inlet passages 124 are at least partially blocked, different parameters of the inlet filter 120 components may be adjusted. For instance, the material and dimensions of the elastomeric ring 126 may be selected to achieve a specific sensitivity of the inlet filter 120 to a pressure drop across the plate 128 and specific amount of deflection. In addition, the dimensions and material of the plate 128 may be selected to ensure an appropriate amount of deflection when grit build-up occurs. In some embodiments, for example, the elastomeric ring 126 is formed from thermoplastic vulcanizates (TPV) and/or silicone. In some approaches, the material of the plate 128 is polyethylene and may be the same material as the emitter housing 102. The size of the plate 128 may be large enough to include all the inlet openings 122 while being small enough to permit the elastomer ring 126 to deflect the plate 128.

In certain approaches, the elastomeric ring 126 has a specific thickness. For instance, in embodiments, the thickness may be about 0.007 to about 0.025 inches, about 0.010 to about 0.020 inches, or about 0.010 to about 0.015 inches. In embodiments, a Shore A hardness of the elastomeric ring 126 may be about 40 to about 70. In some approaches, a width of the freely hanging portion of the ring 126 may be about 0.020 inches to about 0.050 inches.

The inlet filter 120 also may be configured to achieve a specific amount of deflection when a pressure drop occurs. For instance, in some approaches, the plate 128 may move about 0.004 inches to about 0.02 inches as a result of pressure drops across the plate between about 5 psi to about 30 psi or about 10 psi to about 30 psi. In some approaches, the inlet filter 120 may be configured to deflect at least about 0.004 inches at about a 5 psi pressure drop.

With reference to FIGS. 1, 4-6, 8, 10-11, and 16, when the water flows into the emitter 100 through the annular inlet passages 124, the water enters an initial inlet portion 115 at a first (inlet) end 109a of the emitter 100. The inlet portion 115 is a generally open space except for the rods 155. Water flows downstream through the pressure-reducing flow passage 150 and towards the outlet 144 at a second (outlet) end 109b of the emitter 100. Additionally, in embodiments, some of the water flows into a separate ingress passage 117 to a pressure compensation chamber 116.

The pressure-reducing flow passage 150 is a tortuous path that may include, for example, alternating, flow diverting baffles or ribs 151 projecting partially into the flow passage 150 and causing directional changes in water flow. The pressure-reducing flow passage 150 causes a significant reduction in water pressure. The pressure-reducing flow passage 150 may be formed in part within the base 140a of the second housing 140, with two substantially parallel side walls 153a, 153b projecting upwards from the base 140a and the alternating baffles 151 projecting inwardly into the flow passage 150 from the side walls 153a, 153b. In some approaches, a continuous wall 152 forms the side walls 153a, 153b of the pressure-reducing flow passage 150 as well as a side wall 156 (e.g., an annular side wall) of a water metering chamber 160 downstream of the pressure-reducing flow passage 150. The diaphragm 180 may form an upper boundary of both the pressure-reducing flow passage 150 and the water metering chamber 160, seated on the side walls 153a, 153b of the pressure-reducing flow passage 150 and on the side wall 156 of the water metering chamber 160.

In some configurations, the baffles 151 have a pointed or triangular shape, though other shapes are possible. The baffles 151 may have a constant height that may, for example, be substantially level with the side walls 153a, 153b or may have a tapering height. The precise configuration of the pressure-reducing flow passage 150 (e.g., the number, size, and shapes of the baffles 151 and the dimensions of the passage) may be modified to attain a desired level of pressure reduction.

As noted above, some of the water may flow into a separate ingress passage 117 to a pressure compensation chamber 116 instead of flowing into the pressure-reducing flow passage 150. In embodiments, the ingress passage 117 and pressure compensation chamber 116 may be defined in part by a wall 118 projecting from the base 111 of the first housing 110 into the interior 114 of the emitter 100. In some approaches, the wall 118 is a continuous wall that defines two side wall portions 119a, 119b of the ingress passage 117 and a side wall 116a (e.g., annular side wall) of the pressure-compensation chamber 116 at the end of the ingress passage 117. The side wall portions 119a, 119b and side wall 116a may be generally vertically aligned with the side walls 153a, 153b of the pressure-reducing flow passage 150 and the side wall 156 of the water metering chamber 160, respectively. Thus, the ingress passage 117 and the pressure-regulating flow passage 150 may have similar dimensions (e.g., same length and width) while the pressure compensation chamber 116 and water metering chamber 160 may have similar dimensions (e.g., same diameter or length/width).

In embodiments, the diaphragm 180 is sandwiched between side walls 119a, 119b, 116a and side walls 153a, 153b, 156, respectively. Thus, the diaphragm 180 may constitute a bottom to both the ingress passage 117 and the pressure-compensation chamber 116 and a top to both the pressure-reducing flow passage 150 and the water metering chamber 160. Specifically, the diaphragm 180 may include an elongated strip portion 18a that overlays the pressure-reducing flow passage 150 and a widened end portion 182 that overlays the water metering chamber 160 and defines a deflectable bottom to the pressure-compensation chamber 116. A plurality of posts 165 (e.g., four posts) may extend upwards from the base 140a of the second housing 140 for registering the diaphragm 180 therebetween.

In embodiments, the pressure-compensation chamber 116 is separated from the water metering chamber 160 by the diaphragm 180. Water in the ingress passage 117 passes into the pressure-compensation chamber 116, which performs a pressure-compensating function with respect to the water in the metering chamber 160, described further below.

With reference to FIGS. 4, 10, 11, and 16 water exiting the pressure-reducing flow passage 150 flows into the water metering chamber 160 at the second (outlet) end 109b of the emitter 100. The water metering chamber 160 is positioned beneath the pressure-compensation chamber 116, defined in part by a water metering surface 161 and the overlaying diaphragm 180. Specifically, during operation of the emitter 100, water pressure in the pressure-compensation chamber 116, which is reflective of pressure fluctuations in the supply tube 1000, causes the diaphragm 180 to flex between a fully relaxed position and a fully distended position, changing the size of the water metering chamber 160. In turn, this change in size of the water metering chamber 116 regulates water flow. Further, in some embodiments, the diaphragm 180 has a similar pressure-compensating function with respect to the ingress passage 117 and the pressure-regulating flow passage 150. More specifically, water pressure in the ingress passage 117 can cause the diaphragm 180 to distend into the pressure-regulating flow passage 150, changing the size of the pressure-regulating flow passage 150.

The water metering chamber 160 includes a groove 162 in the water metering surface 161 for regulating fluid flow. The groove 162 has a recessed annular portion 163 that extends about the circumference of the water metering surface 161 and a recessed radial portion 164 connecting a point along the annular portion 163 to the emitter outlet 144. When the diaphragm 180 is fully distended by relatively high pressure, it is deflected into and presses against the water metering surface 161. The groove 162 provides a flow path along the recessed annular portion 163 to the recessed radial portion 164 and out through the emitter outlet 144. The groove 162 allows output flow even at a relatively high water pressure, such that deflection of the diaphragm 180 does not completely obstruct fluid flow through the water metering chamber 160. Thus, the pressure compensation chamber 116, diaphragm 180, water metering chamber 160, water metering surface 161, and groove 162 together act as a pressure-dependent or pressure-compensating function to offset differences in water pressure in the irrigation tube 1000 to maintain flow rate through the emitter 100 at a relatively constant level.

With reference to FIGS. 4, 12, and 16, the water next flows through the outlet 144 into the outlet bath 145 formed between the base 108 of the emitter 100 and the wall 1010 of the supply tube 1000. Water collected in the bath 145 is subsequently discharged from the tube outlet 1007. In some embodiments, a copper member (not shown) is used at the outlet 144 to prevent plant root intrusion, for instance, as described in U.S. Publication Nos. 2010/0282873 and 2016/0057947, the contents of which are incorporated herein by reference in their entireties. Specifically, the copper member may be in front of the emitter outlet 144 to inhibit root growth into the outlet 144. In one approach, the copper member is a thin copper plate having a first hole positioned over a locator peg 172 and a second hole positioned over the emitter outlet 144.

In some approaches, the raised rim 142 at the exterior side 143b of the second housing 140 forms two opposing side walls 147a, 147b of the outlet bath 145. The outlet bath 145 may additionally be bounded by two opposing end walls 149a, 149b. In some embodiments, the side walls 147a, 147b and the end walls 149a, 149b have a curvature corresponding to the curvature of the tube 1000 to sealingly bond with the tube 1000. In some approaches, the outlet bath 145 is partitioned into multiple outlet baths. For instance, there may be a partition wall 148 that divides the outlet bath 145 into a first sub-bath 146a and a second sub-bath 146b, as described in U.S. Publication No. 2016/0057947, the contents of which are incorporated herein by reference in their entirety. The partition wall 148 serves as a physical barrier that reduces the effective volume of the outlet bath 145 in which roots may potentially intrude. The partition wall 148 also prevents dirt and other debris from accumulating at “dead zones” of the outlet bath 145 at its far end.

The partition wall 148 may have a curvature corresponding to the curvature of the tube 1000. In one approach, the end walls 149a, 149b and the partition wall 148 have the same height such that the partition wall 148 also may be bonded to the supply tube 1000. In another approach, the height of the partition wall 148 is less than the height of the end walls 149a, 149b. The partition wall 148 may completely separate the sub-baths 146a, 146b from one another or may partially or substantially separate the sub-baths 146a, 146b from one another.

The matter set forth in the foregoing description and accompanying drawings is offered by way of example and illustration only and not as a limitation. While certain embodiments have been shown and described, it will be apparent to those skilled in the art that additions, changes, and modifications may be made without departing from the broader aspects of the technological contribution. The actual scope of the protection sought is intended to be defined in the following claims.

What is claimed is:

1. A drip emitter comprising:
a body mountable to an inner surface of supply tube, the body comprising an inlet to receive fluid from the supply tube, an outlet, and a flow path from the inlet to the outlet,
the inlet including a plate having a first side exposed to fluid in the supply tube, a second side facing an interior of the body, and at least one inlet opening, the plate having a first state and a second state,
wherein in an operational state of the emitter the plate moves from the first state to the second state as a result of debris interfering with flow through the inlet opening,
wherein in the second state at least some of the debris is cleared from the inlet opening.

2. The drip emitter of claim 1, wherein the plate moves towards the first state after at least some of the debris is cleared from the inlet opening.

3. The drip emitter of claim 1, wherein the plate moves from the first state to the second state due to a pressure drop across the plate caused by debris at least partially blocking the at least one inlet opening.

4. The drip emitter of claim 1, wherein the body comprises a first rod projecting from an interior of the body into a first inlet opening of the at least one inlet opening and defining a first annular inlet passage between the first rod and the first inlet opening.

5. The drip emitter of claim 4, wherein the annular inlet passage is sized to prevent debris larger than about 120 mesh from passing through the annular inlet passage.

6. The drip emitter of claim 4, wherein in the first state of the plate an end of the first rod is substantially coplanar with the first side of the plate and in the second state of the plate the end of the first rod projects from the first inlet opening past the plate.

7. The drip emitter of claim 4, wherein the first rod includes a plurality of ribs.

8. The drip emitter of claim 1, further including a diaphragm that couples the plate to the body and permits the plate to move between the first state and the second state.

9. The drip emitter of claim 8, wherein the diaphragm has a thickness of about 0.008 inches to about 0.017 inches.

10. A drip emitter comprising:
a main body mountable to a supply tube, the main body comprising an inlet portion positioned to receive fluid from the supply tube, an outlet, and a flow path from the inlet portion to the outlet,
the inlet portion including:
a moveable inlet body having an outer surface exposed to fluid in the supply tube and an inner surface facing an interior of the main body, and defining at least one inlet opening, and
at least one rod extending from an interior of the emitter into the at least one inlet opening,
wherein in an operational state of the emitter, movement of the moveable inlet body relative to the at least one rod at least partially clears debris from the at least one inlet opening.

11. The drip emitter of claim 10, wherein movement of the moveable inlet body relative to the at least one rod is responsive to a pressure drop across the moveable inlet body due to debris at least partially blocking the at least one inlet opening.

12. The drip emitter of claim 10, wherein the moveable inlet body includes a plate and a diaphragm, the diaphragm coupling the plate to the main body and permitting movement of the plate.

13. The drip emitter of claim 10, wherein the moveable inlet body defines at least two inlet openings and wherein at least two rods extending respectively through the at least two inlet openings.

14. The drip emitter of claim 10, wherein an annular inlet passage is defined between the at least one rod and the at least one inlet opening.

15. The drip emitter of claim 10, wherein movement of the moveable inlet body relative to the at least one rod increases exposure of an end of the at least one rod to fluid in the supply tube.

16. The drip emitter of claim 10, wherein a first rod of the at least one rod includes a plurality of ribs.

17. An irrigation drip emitter inlet comprising:
an emitter inlet body attachable to a tube and having:
a top wall, a bottom wall, and at least one side wall defining an interior of the emitter inlet body;
a moveable inlet element disposed in the top wall, having an outer surface exposed to fluid in the tube, and an inner surface facing the interior, and at least one inlet opening therein, and
at least one rod projecting from the bottom wall and into the at least one inlet opening,
wherein movement of the moveable inlet element relative to the at least one rod reduces debris build-up at the at least one inlet opening.

18. The irrigation drip emitter inlet of claim 17, wherein movement of the moveable inlet element relative to the at least one rod projects the at least one rod from the at least one inlet opening beyond the outer surface.

19. The irrigation drip emitter inlet of claim 17, wherein the moveable inlet body includes a plate defining the at least one inlet opening and comprising an annular elastomeric element engaging the plate.

20. The irrigation drip emitter inlet of claim 17, wherein an annular inlet passage is defined between the at least one rod and the at least one inlet opening.

21. An irrigation drip emitter comprising:
the irrigation drip emitter inlet of claim 17, an emitter outlet, and a pressure-reducing portion between the irrigation drip emitter inlet and the emitter outlet, the irrigation drip emitter inlet, the emitter outlet, and the pressure-reducing portion being in fluid communication with one another.
